(19) United States
(12) Patent Application Publication
(10) Pub. No.: US 2019/0347682 A1
(43) Pub. Date: Nov. 14, 2019

(54) PRICE OPTIMIZATION SYSTEM, PRICE OPTIMIZATION METHOD, AND PRICE OPTIMIZATION PROGRAM

(71) Applicant: NEC Corporation, Minato-ku, Tokyo (JP)

(72) Inventors: Akihiro YABE, Tokyo (JP); Ryohei FUJIMAKI, Tokyo (JP)

(73) Assignee: NEC Corporation, Minato-ku, Tokyo (JP)

(21) Appl. No.: 16/481,550

(22) PCT Filed: Feb. 22, 2017
(86) PCT No.: PCT/JP2017/006646

§ 371 Date: Jul. 29, 2019

(51) Int. Cl. G06Q 30/02; G06Q 10/04; G06N 20/00; G06N 5/04

(52) U.S. Cl. CPC G06Q 30/0206; G06N 5/046; G06N 20/00; G06Q 10/04

(57) ABSTRACT

A feature selection unit 81 selects, from a set of features that can influence the sales volume of a product, a first feature set as a set of features that influence the sales volume and a second feature set as a set of features that influence a price of the product. A learning unit 82 learns a predictive model in which features included in the first feature set and the second feature set are set as explanatory variables, and the sales volume is set as a prediction target. An optimization unit 83 optimizes the price of the product under constraint conditions to increase a sales revenue defined by using the predictive model as an argument. Further, the learning unit 82 learns a predictive model in which at least one feature included in the second feature set but not included in the first feature set is set as an explanatory variable.

### TECHNICAL FIELD

The present invention relates to a price optimization system, a price optimization method, and a price optimization program for optimizing a price based on prediction.

### BACKGROUND ART

When a predictive model or a discriminant model is built, feature selection processing for selecting a meaningful feature from multiple features is generally performed. Making feature selections can lead to expressing which features are important in observed data and how they are related to each other.

For example, Patent Literature (PTL) 1 describes a feature selection device for selecting a feature used for malware determination. The feature selection device described in PTL 1 does machine learning of readable character strings included in a malware executable file in advance to extract words often used in the malware. Further, the feature selection device described in PTL 1 makes any one of features in a feature group appearing as a group in verification data among feature candidate groups representative of the feature group, and eliminates features (redundancy features) other than the representative.

### CITATION LIST

### Patent Literature

PTL 1: Japanese Patent Application Laid-Open No. 2016-31629

### SUMMARY OF INVENTION

### Technical Problem

If a target can be predicted, a future optimization strategy can be considered based on the prediction. For example, when a predictive model is generated, optimization based on this predictive model can be made. It can be said that the optimization based on a predictive model is to optimize features included in the predictive model to maximize the value of an objective function represented by the predictive model. As an example of such optimization, there is an example of optimizing a price using a predictive model for sales volume.

Using a common learning method based on past data, the above-described predictive model can be built. In doing so, in the common learning method, redundant features are generally eliminated from the predictive model and unselected as described in PTL 1. The elimination of redundant features can mitigate the effect of the curse of dimensionality, speed up the learning, and improve the readability of the model without having a large adverse effect on the prediction accuracy. The elimination of redundant features is also beneficial from the viewpoint of prevention of overfitting.

Here, there may be a case where one feature used for optimization of a prediction target is affected by the other feature used for prediction of the prediction target. In other words, there may be a case where there is a cause-and-effect relationship between one feature and the other feature. When a feature is selected without consideration of such a cause-and-effect relationship, an optimization problem may arise even without any problem with the prediction accuracy. A situation where a problem occurs will be described below using a specific example.

Here, an optimization problem with the price of an umbrella is considered. Assuming that x is the price of the umbrella, y is the sales volume of the umbrella, and z is a variable representing weather, the sales volume y is predicted. Here, x and z are features likely to affect the sales volume of the umbrella. It is assumed that a shop owner sets the price of the umbrella high in expectation of rain because the sales volume of the umbrella on a rainy day is large in past data, while the shop owner sets the price of the umbrella low in expectation of shine because the sales volume of the umbrella on a sunny day is small in past data.

When this situation is expressed by using the above variables, (x, y, z)=(“high,” “large,” “rainy”) on a rainy day and (x, y, z)=(“low,” “small,” “sunny”) on a sunny day. In this case, y is predicted by using x and z. However, when y is predicted in such a situation, since x and z are strongly correlated, only x is enough to describe y (i.e., since z=rainy is always true in case of x=high), z is regarded as a redundant feature by feature selection processing. In other words, z is eliminated by the feature selection processing. Thus, the probability that p(y=large|x=high)=1 is obtained in the prediction.

Since z as a feature is not selected, it can be said that, from the above probability equality, y will be larger if x is higher. Therefore, from the result of optimization for making y higher, it can be determined that “the umbrella is always sold at a high price.” This result means the sales volume increases as the umbrella is sold at a high price even on a sunny day, which is clearly counterintuitive. This results from a difference between the result of intervention of optimization and the prediction. In the above example, the volume sold naturally when the price is high is different from the volume sold when the price is set high. In other words, when the value obtained by intervention is expressed as do(variable), the following relationship in Expression 1 is established:

p(y=large|x=high)≠p(y=large|do(x=high)) (Expression 1)

The prediction expression p(y=large|x=high) illustrated in Expression 1 has a high accuracy in past data. However, there is a need to pay attention to the fact that there is no actual data on the “umbrella sold at a high price on sunny days.” In this case, an optimizer makes an optimization based on a high prediction accuracy even though a strategy combination as (x=high, z=sunny) does not exist in the past data. This can be regarded as such a phenomenon that the optimizer cannot make an appropriate determination because information as a high-risk strategy is not input by feature selection. When the optimization is made without considering the situation as illustrated in Expression 1, a feature risky as an optimization strategy can be selected. In other words, the prediction accuracy in a non-observed situation is not guaranteed at the prediction stage, whereas the non-observed situation in the past is considered at the optimization stage.

Suppose that there is a predictive model learned by making feature selections appropriate from the viewpoint of prediction, i.e., by making such feature selections that eliminate redundant features from the viewpoint of prediction, and using only the selected features. It would appear that this predictive model provides good performance as long as it is used for the purpose of prediction. However, when this predictive model is used for the purpose of optimization, proper optimization may not be able to be made as a result of selecting a risky strategy. The present inventors have found that a set of features necessary to learn a predictive model used only for the purpose of prediction does not always correspond to a set of features necessary to learn a predictive model used for optimization based on prediction. It is preferred that when optimization based on a predictive model is made, all features necessary for proper optimization should be able to be selected even though some of the features are redundant for the purpose of prediction.

Therefore, it is an object of the present invention to provide a price optimization system, a price optimization method, and a price optimization program, capable of selecting a feature to make a price optimization in such a manner as to be able to avoid a risky strategy when the price is optimized based on prediction.

### Solution to Problem

A price optimization system according to the present invention includes: a feature selection unit which selects, from a set of features that can influence the sales volume of a product, a first feature set as a set of features that influence the sales volume and a second feature set as a set of features that influence a price of the product; a learning unit which learns a predictive model in which features included in the first feature set and the second feature set are set as explanatory variables, and the sales volume is set as a prediction target; and an optimization unit which optimizes the price of the product under constraint conditions to increase a sales revenue defined by using the predictive model as an argument, wherein the learning unit learns a predictive model in which at least one feature included in the second feature set but not included in the first feature set is set as an explanatory variable.

A price optimization method according to the present invention includes: selecting, from a set of features that can influence the sales volume of a product, a first feature set as a set of features that influence the sales volume and a second feature set as a set of features that influence a price of the product; learning a predictive model in which features included in the first feature set and the second feature set are set as explanatory variables, and the sales volume is set as a prediction target; and optimizing the price of the product under constraint conditions to increase a sales revenue defined by using the predictive model as an argument, wherein upon learning the predictive model, a predictive model in which at least one feature included in the second feature set but not included in the first feature set is set as an explanatory variable is learned.

A price optimization program according to the present invention causing a computer to execute: a feature selection process of selecting, from a set of features that can influence the sales volume of a product, a first feature set as a set of features that influence the sales volume and a second feature set as a set of features that influence a price of the product; a learning process of learning a predictive model in which features included in the first feature set and the second feature set are set as explanatory variables, and the sales volume is set as a prediction target; and an optimization process of optimizing the price of the product under constraint conditions to increase a sales revenue defined by using the predictive model as an argument, wherein a predictive model in which at least one feature included in the second feature set but not included in the first feature set is set as an explanatory variable is learned in the learning process.

### Advantageous Effects of Invention

According to the present invention, when the price is optimized based on prediction, a feature to make a price optimization can be selected to be able to avoid a risky strategy.

### BRIEF DESCRIPTION OF DRAWINGS

FIG. 1 is a block diagram illustrating one embodiment of a price optimization system according to the present invention.

FIG. 2 is a flowchart illustrating an operation example when the price optimization system performs price optimization.

FIG. 3 is a flowchart illustrating an example of processing in which the price optimization system selects features according to the specification of a prediction target and the specification of an instrumental variable.

FIG. 4 is an explanatory chart illustrating an example of shop sales records recorded in a database.

FIG. 5 is a block diagram illustrating an outline of the price optimization system according to the present invention.

FIG. 6 is a schematic block diagram illustrating the configuration of a computer according to at least one embodiment.

### DESCRIPTION OF EMBODIMENT

First of all, the terms used in the present invention will be described. The term “feature” is used as the meaning of an attribute name in the embodiment. Further, a specific value indicated by the attribute is referred to as an attribute value. An example of the attribute is a price, and an example of the attribute value in this case is 500 yen. In the following description, the role of the “feature” is not particularly limited, which may mean an explanatory variable, a prediction target, or an instrumental variable as well as the meaning of the attribute name.

The explanatory variable means a variable that can influence the prediction target. In the example of the optimization problem with the price of an umbrella described above, “whether it is the end of the month or not” and the like as well as “whether it rains in the morning or not,” “whether it rains in the afternoon or not,” and the like correspond to explanatory variables. In the embodiment, explanatory variable candidates are input as input when a feature selection is made. In other words, in the feature selection, an explanatory variable that can influence a prediction target is selected as a feature from among the explanatory variable candidates, and output as the result. In other words, the explanatory variable selected in the feature selection is a subset of the explanatory variable candidates.

In the field of machine learning, the prediction target is also called an “objective variable.” In the following description, the variable representing the prediction target is referred to as an explained variable to avoid confusion with the “objective variable” commonly used in optimization processing to be described later. Thus, it can be said that the predictive model is such a model that represents an explained variable by using one or more explanatory variables. In the embodiment, a model obtained as a result of a learning process may also be called a “learned model.” In the embodiment, the predictive model is a specific form of the learned model.

The instrumental variable means such a variable as to receive any intervention (for example, by a person) during operation. Specifically, it means a variable as a target of optimization in the optimization processing. Although the instrumental variable is a variable generally called the “objective variable” in the optimization processing, the term “objective variable” is not used to describe the present invention in order to avoid confusion with the “objective variable” used in the machine learning as described above. In the example of the optimization problem with the price of an umbrella described above, the “price of an umbrella” corresponds to the instrumental variable.

Note that the instrumental variable is part of the explanatory variable. In the following description, when there is no need to discriminate between the explanatory variable and the instrumental variable, the variable is simply called the explanatory variable, while when the explanatory variable is discriminated from the instrumental variable, the explanatory variable means a variable other than the instrumental variable. Further, when the explanatory variable is discriminated from the instrumental variable, the explanatory variable other than the instrumental variable may also be denoted as an external variable.

An objective function means an objective function for optimizing an instrumental variable under given constraint conditions in the optimization processing to calculate the maximum or minimum value. In the example of the optimization problem with the price of an umbrella described above, a function for calculating a sales revenue (sales volume x price) corresponds to the objective function.

An embodiment of the present invention will be described below with reference to the accompanying drawings.

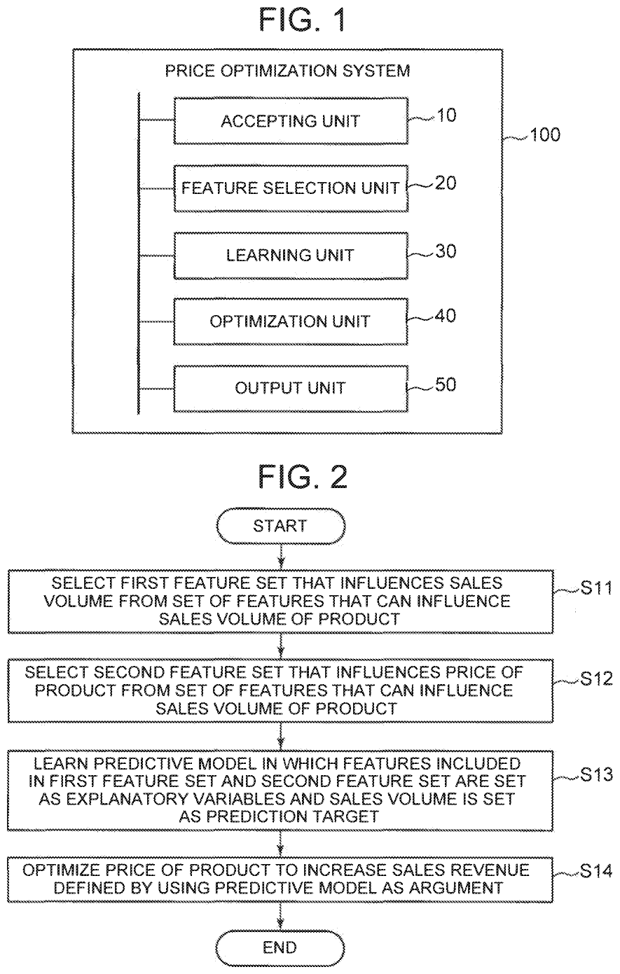

FIG. 1 is a block diagram illustrating one embodiment of a price optimization system according to the present invention. A price optimization system 100 of the embodiment is a system for performing optimization based on prediction, including an accepting unit 10, a feature selection unit 20, a learning unit 30, an optimization unit 40, and an output unit 50. Since the price optimization system 100 of the embodiment makes feature selections as a specific form, the price optimization system 100 can be called a feature selection system.

In other words, the price optimization system of the embodiment is a system for leaning a predictive model used for prediction of a prediction target, and a system for calculating an instrumental variable to optimize, under constraint conditions, an objective function represented using the predictive model. Here, the objective function represented using the predictive model means both an objective function defined by using, as an argument, a predicted value predicted using the predictive model, and an objective function defined by using, as an argument, a parameter of the predictive model.

The accepting unit 10 accepts a prediction target (that is, an explained variable), a set of features (that is, explanatory variable candidates) that can influence the prediction target, and a target of optimization (that is, an instrumental variable). Specifically, the accepting unit 10 accepts the specification as to which feature is an explained variable y, and the specification as to which feature is an instrumental variable x. Further, the accepting unit 10 accepts candidates for explanatory variable z. When the price optimization system 100 holds candidates for explanatory variable z beforehand, the accepting unit 10 may accept two kinds of specifications, i.e., the specification of the prediction target as the explained variable y and the specification of the instrumental variable x.

As described above, since the instrumental variable x is part of the explanatory variable z, the accepting unit 10 may also accept the candidates for explanatory variable z and an identifier of the instrumental variable x included in the explanatory variable z. In the case of the optimization problem with the price of an umbrella described above, the explained variable y represents the sales volume of an umbrella, the instrumental variable x represents the price of the umbrella, and the explanatory variable z represents weather. The accepting unit 10 also accepts various parameters required in the subsequent processes.

The feature selection unit 20 selects features used for learning of a predictive model. Specifically, the feature selection unit 20 selects a set of features that influence a prediction target from the set of features that can influence the prediction target accepted by the accepting unit 10. Hereinafter, the set of features that influence the prediction target is called a first feature set. For example, in the case of the optimization problem with the price of the umbrella described above, price is selected as a set (first feature set) that influences the sales volume from the set of features that can influence the sales volume of the umbrella (product) as the prediction target. In this case, if there are two or more features redundant to each other to describe the prediction target, some of redundant features will be eliminated from the first feature set. In the example described above, price and weather as features for describing the prediction target (sales volume) are regarded as features redundant to each other and either one of the price and the weather is eliminated from the first feature set. In the above-described example, weather is eliminated.

Further, the feature selection unit 20 of the embodiment selects a set of features that influence the instrumental variable from the set of features that can influence the prediction target accepted by the accepting unit 10. Hereinafter, the set of features that influence the instrumental variable is called a second feature set. For example, in the case of the optimization problem with the price of the umbrella described above, weather is selected as a set (second feature set) that influences the price as the instrumental variable. In this case, if there are two or more features redundant to each other to describe the instrumental variable, some of redundant features will be eliminated from the second feature set.

Thus, the feature selection unit 20 selects, from the set of features that can influence the sales volume of the product as the prediction target, the first feature set that influences the prediction target (sales volume) and the second feature set that influences the instrumental variable (price of product). Here, the first feature set is a feature set necessary and sufficient for learning a predictive model used for the purpose of prediction alone. Features included in the second feature set but not included in the first feature set are not indispensable features for learning the predictive model used for the purpose of prediction alone but are features necessary for learning a predictive model used for optimization based on prediction. It is assumed that the feature selection unit 20 does not eliminate the instrumental variable itself (i.e., that the instrumental variable is always left in either of the first feature set and the second feature set).

Although the case where features are selected is illustrated above using the specific example, the feature selection unit 20 has only to select the first feature set and the second feature set by using a generally known feature selection technique. As a feature selection technique, for example, there is L1 regularization. However, the method for the feature selection unit 20 to select features is not limited to L1 regularization.

The feature selection includes, for example, feature selection by a greedy method such as matching orthogonal pursuit and selection on the basis of various information amounts. Note that the regularization method is a method of imposing a penalty each time when many features are selected. The greedy method is a method of selecting a determined number of features from dominant features. The information amount-based method is a method of imposing a penalty based on a generalization error caused by selecting many features. A specific method for feature selection using L1 regularization will be described later.

The learning unit 30 learns a predictive model in which features included in the first feature set and features included in the second feature set are set as explanatory variables, and the feature of the prediction target is set as the explained variable. In the case of the price example, the learning unit 30 learns a predictive model in which the features included in the first feature set and the features included in the second feature set are set as explanatory variables, and the sales volume is set as the prediction target. In this case, the learning unit 30 uses, as an explanatory variable, at least one feature included in the second feature set but not included in the first feature set to learn the predictive model. Note that it is preferred that the learning unit 30 should set, as explanatory variables, all of features included in the first feature set and features included in the second feature set.

Since any feature included in the second feature set is not selected in typical feature selection, it is difficult to do learning including features as influencing optimization processing to be described later. In contrast, in the embodiment, since the learning unit 30 learns a model using, as an explanatory variable, a feature included in the second feature set but not included in the first feature set, a model in consideration of the optimization processing as postprocessing can be generated.

The optimization unit 40 optimizes a value of the instrumental variable to maximize or minimize the function of the explained variable defined by using, as an argument, the predictive model generated by the learning unit 30. In the example of sales, the optimization unit 40 optimizes the price of the product under constraint conditions to increase the sales revenue defined by using the predictive model as an argument. More specifically, the optimization unit 40 optimizes the price of the product under constraint conditions to increase the sales revenue defined by using, as an argument, a sales volume predicted by using the predictive model.

When the optimization is made by using the predictive model, information representing a distribution of prediction errors can be input to the optimization unit 40 to make an optimization based on the information. In other words, a penalty can be imposed on a strategy with large prediction errors to make an optimization so as to avoid a high-risk strategy. In comparison with optimization without using prediction errors, this is called robust optimization, probability optimization, or the like. For example, when the predictive model is expressed as y=a₁x₁+b, the distribution of prediction errors is a distribution related to a₁ and b. The distribution of prediction errors is, for example, a variance-covariance matrix. The distribution of prediction errors input here depends on the content of the predictive model, and more specifically, depends on features included in the second feature set but not included in the first feature set.

For example, suppose that the instrumental variable is x₁, a feature as an explanatory variable included in the first feature set is z₁, a feature as an explanatory variable included in the second feature set but not included in the first feature set is z₂, and the explained variable is y. When such a common feature selection that takes no account of the feature (i.e., z₂) included in the second feature set but not included in the first feature set is made, a predictive model as illustrated, for example, in the following expression 2 is generated.

y=a₁x₁+a₂z₁+b (Expression 2)

On the other hand, when a feature selection in consideration of z₂ is made like in the embodiment, a predictive model as illustrated, for example, in the following expression 3 is generated.

y=a₁x₁+a₂z₁+a₃z₂+b (Expression 3)

Thus, since the feature selection is so made that even the feature (z₂) that is not necessarily required for the generation of the predictive model will be included in the predictive model, a more suitable distribution of prediction errors can be input to the optimization unit 40.

In the optimization problem with the price of the umbrella described above, Expression 2 mentioned above corresponds to a case where the feature z related to weather is not selected, and Expression 3 mentioned above corresponds to a case where the feature z related to weather is selected. Expression 2 mentioned above indicates that the prediction accuracy of the distribution of prediction errors is high both when the price is high and when the price is low. On the other hand, Expression 3 mentioned above includes a prediction error distribution representing information that the prediction accuracy is good when the price is high on a rainy day but the prediction accuracy is low when the price is high on a sunny day. Therefore, the optimization can be made in the light of circumstances as illustrated in Expression 3 to avoid such a situation that a strategy high in risk is selected due to the feature selection.

The method for the optimization unit 40 to perform optimization processing is optional, and it is only necessary to optimize the instrumental variable (price) using a method of solving a common optimization problem.

The output unit 50 outputs the optimization results. For example, when such a price optimization as to increase the sales revenue is made, the output unit 50 may output the optimum price and the sales revenue at the price.

In addition to the optimization results, the output unit 50 may also output the first feature set and the second feature set selected by the feature selection unit 20. In this case, the output unit 50 may output the feature sets in such a form that the features included in the first feature set can be discriminated from the features included in the second feature set but not included in the first feature set. Examples of output methods in a discriminable form include a method of changing the color of the features included in the second feature set but not included in the first feature set, a method of highlighting the features, a method of changing the size of the features, a method of displaying the features in italics, and the like. The output destination of the output unit 50 is optional, and it may be, for example, a display device (not illustrated) such as a display device included in the price optimization system 100.

The first feature set consists of features selected in general feature selection processing, and the second feature set consists of features selected in consideration of the optimization processing as postprocessing and which do not appear in the general feature selection processing. Such features are displayed distinctively to enable a user to grasp and select a suitable feature used to execute the optimization processing. As a result, the user can view displayed information and use domain knowledge to adjust the feature.

The accepting unit 10, the feature selection unit 20, the learning unit 30, the optimization unit 40, and the output unit 50 are realized by a CPU of a computer to operate according to a program (price optimization program, feature selection program).

For example, the program is stored in a storage unit (not illustrated) included in the price optimization system 100 so that the CPU may read the program to operate according to the program as the accepting unit 10, the feature selection unit 20, the learning unit 30, the optimization unit 40, and the output unit 50.

The accepting unit 10, the feature selection unit 20, the learning unit 30, the optimization unit 40, and the output unit 50 may also be realized by dedicated hardware, respectively.

Next, an operation example of the price optimization system 100 of the embodiment will be described. FIG. 2 is a flowchart illustrating an operation example when the price optimization system 100 performs price optimization.

The feature selection unit 20 selects the first feature set that influences the sales volume (i.e., the explained variable y) from the set of features (i.e., candidates for explanatory variable z) that can influence the sales volume of a product (step S11). Further, the feature selection unit 20 selects the second feature set that influences the price of the product (i.e., the instrumental variable x) from the set of features that can influence the sales volume (step S12).

The learning unit 30 sets, as explanatory variables, features included in the first feature set and the second feature set to learn a predictive model using the sales volume as a prediction target. In this case, the learning unit 30 learns a predictive model using, as the explanatory variable, at least one feature included in the second feature set but not included in the first feature set (step S13).

The optimization unit 40 optimizes the price of the product under constraint conditions to increase the sales revenue defined by using the predictive model as an argument (step S14).

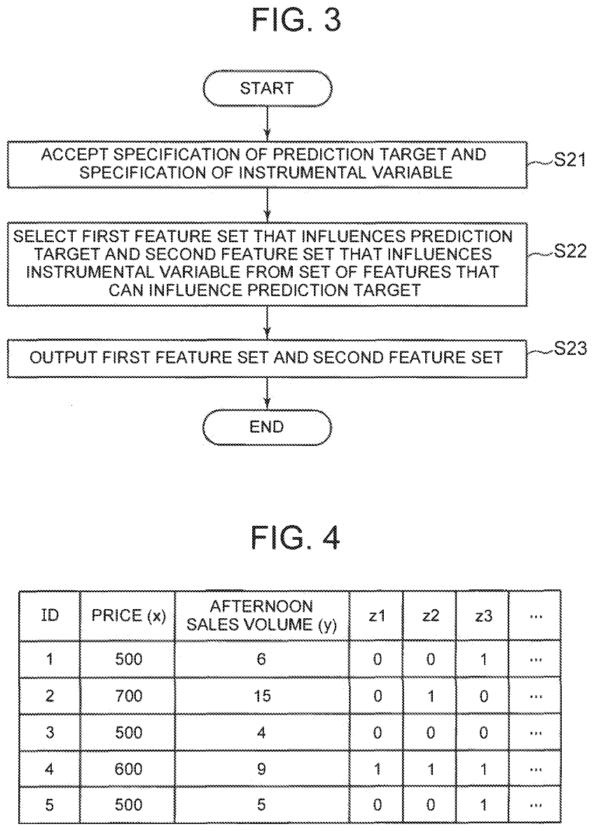

Further, FIG. 3 is a flowchart illustrating an example of processing in which the price optimization system 100 selects features according to the specification of a prediction target and the specification of an instrumental variable.

The accepting unit 10 accepts the specification of a prediction target (i.e., the explained variable y) and the specification of an instrumental variable (i.e., the instrumental variable x) (step S21). The feature selection unit 20 selects the first feature set that influences the prediction target and the second feature set that influences the instrumental variable from the set of features (i.e., candidates for explanatory variable z) that can influence the prediction target (step S22). The feature selection unit 20 may input the selected first feature set and second feature set to the learning unit 30.

The output unit 50 outputs the first feature set and the second feature set (step S23). In this case, the output unit 50 may output features included in the first feature set and features included in the second feature set but not included in the first feature set in a discriminable form.

As described above, in the embodiment, the feature selection unit 20 selects, from the set of features that can influence the sales volume of a product, the first feature set that influences the sales volume and the second feature set that influences the price of the product, the learning unit 30 sets, as explanatory variables, features included in the first feature set and the second feature set to learn the predictive model using the sales volume as the prediction target, and the optimization unit 40 optimizes the price of the product under constraint conditions to increase the sales revenue defined by using the predictive model as an argument. In this case, the learning unit 30 learns the predictive model using, as the explanatory variable, at least one feature included in the second feature set but not included in the first feature set.

Thus, when the price is optimized based on prediction, a feature used to perform price optimization can be selected in such a manner as to avoid a risky strategy.

Further, in the embodiment, the accepting unit 10 accepts the specification of the prediction target and the specification of the instrumental variable, the feature selection unit 20 selects, from the set of features that can influence the prediction target, the first feature set that influences the prediction target and the second feature set that influences the instrumental variable, and the output unit 50 outputs the first feature set and the second feature set.

Thus, when features used to learn the predictive model are selected, a feature(s) necessary for proper optimization performed by using the predictive model can be known.

Next, processing performed by the price optimization system 100 of the embodiment to select features will be described by using a specific example of L1 regularization. As described above, L1 regularization is just one specific example of many feature selection techniques, and the feature selection technique usable in the present invention is not limited to L1 regularization. Here, such an example that an umbrella sells well in the afternoon on a rainy day is considered. Suppose that the instrumental variable x is the price of the umbrella, the explained variable y is the sales volume of the umbrella, and the explanatory variables z₁ to z₃ are “whether it rains in the morning,” “whether it rains in the afternoon,” and “whether it is the end of the month (after 15 of the month)” using a 0-1 variable, respectively. Here, it is assumed that a real sales volume y is generated as Expression 4 below.

y=−7z₁+14z₂−x/50+15+noise (Expression 4)

In Expression 4, it is assumed such a model that sales increases when it rains in the afternoon (i.e., z₂=1) but sales drops in the afternoon when it rains in the morning (for example, because customers bought the umbrellas in the morning). Further, although the explanatory variable z₃ is a candidate for explanatory variable, it can be said the explanatory variable z₃ is a variable unrelated to the sales. Note that the noise assumes a value of (0, 1, 2) at random to simplify the description.

On the other hand, it is assumed that a shop owner who is aware that the umbrella sells well on a rainy day sets the price of the umbrella based on Expression 5 below.

x=−100z₁+200z₂+500 (Expression 5)

FIG. 4 is an explanatory chart illustrating an example of shop sales records recorded in a database. In the example illustrated in FIG. 4, price x per count unit identified by Id, sales volume y in the afternoon at the time of counting, and the presence or absence of features at the time of counting are recorded. For example, a sales record identified by Id=1 indicates that the sales volume of the umbrella in the afternoon is six when the price is set to 500 yen at the end of the month, where no rain falls both in the morning and in the afternoon.

It is assumed that a feature selection for prediction is made based on such data. In the following description, the feature selection unit 20 uses L1 regularization (Lasso) to select non-zero Iv, for minimizing Expression 6 illustrated below in order to make a feature selection. In Expression 6, the Lasso penalty coefficient is set to 1/10 to simplify the description later.

$$\begin{matrix} [ Math . 1 ] & \\ {min}_{\{ {w}_{0} , {w}_{1} , {w}_{2} , {w}_{3} , c \}} {\sum }_{\{ id = 1 , 2 , … \}} \vert {y}_{id} - ( {w}_{0} {x}_{id} + {w}_{1} {z}_{1 , id} + {w}_{2} {z}_{2 , id} + {w}_{3} {z}_{3 , id} ) + c \vert + \frac{1}{10} {\sum }_{i = 0}^{3} \vert w\_i \vert & ( Expression 6 )\end{matrix}$$

On the assumption that sufficient data are obtained, wᵢ (and properly selected c) which satisfies the relation in Expression 7 or Expression 8 below and a linear combination of them (a×(wᵢ in Expression 7)+(1−a)×(wᵢ in Expression 8)) are both describe data well, and the first item in Expression 6 becomes the minimum. However, the set of wᵢ in Expression 7 is obtained due to the constraint on the sparseness of the second item in Expression 6. This is because the penalty calculated from the second item in the set of wᵢ in Expression 7 is 1/200, whereas the penalty calculated from the second item in the set of w in Expression 8 is 1.5.

Therefore, x is selected as a feature.

w₀= 1/20,w₁=w₂=w₃=0 (Expression 7)

w₀=0,w₁=−5,w₂=10,w₃=0 (Expression 8)

In the specific example, a case where ideal w₀ is obviously small is exemplified. However, even if w₀ is large, a similar phenomenon can be observed by specifying that w₀ is always selected in the feature selection setting. This setting is done particularly on the assumption of optimization in postprocessing when it is desired to leave the feature indicative of the price.

The feature selection unit 20 further selects features describing x in addition to the feature selected based on Expression 6. Specifically, the feature selection unit 20 selects non-zero w′ᵢ to minimize Expression 9 below to make feature selections.

$$\begin{matrix} [ Math . 2 ] & \\ {min}_{\{ {w}_{1}^{′} , {w}_{2}^{′} , {w}_{3}^{′} , {c}^{′} \}} {\sum }_{\{ id = 1 , 2 , … \}} \vert {x}_{id} - ( {w}_{1}^{′} {z}_{1 , id} + {w}_{2}^{′} {z}_{2 , id} + {w}_{3}^{′} {z}_{3 , id} ) + c \vert + \frac{1}{10} {\sum }_{i = 1}^{3} \vert {w}_{i}^{′} \vert & ( Expression 9 )\end{matrix}$$

in the case of w′₁=−100 and w′₂=−200, the first item in Expression 9 becomes the minimum. For example, when the frequency of rainy days is sufficiently high such as a case where it rains in the morning and in the afternoon independently once every five days, the effect of minimize the first item becomes sufficiently large compared with the penalty for the second item. As a result, since w′₁=−100, w′₂=−200 become the solutions, z₁ and z₂ are selected as features. The invention according to the embodiment has been described above by taking the specific example using L1 regularization. The feature selection technique usable in the present invention is not limited to L1 regularization, an any other feature selection technique can be used.

By the feature selection processing described above, that is, by the feature selection processing to further select features describing the instrumental variable in addition to the feature describing the prediction target, x, z₁, and z₂ are selected as features. In other words, since the optimization unit 40 can recognize x, z₁, and z₂ as features necessary for optimization, it can be determined that weather should be considered for optimization to avoid the selection of a risky strategy such as to “sell the umbrella at a high price on a sunny day.”

Here, the reason why the selection of the risky strategy described above can be avoided will be described in more detail. Assuming that features x, z₁, and z₂ are selected correctly, a prediction expression as in Expression 10 below is created to consider obtaining w₀ hat, w₁ hat, and w₂ hat (where hat is superscript \hat{ }) by estimation.

[Math. 3]

ŷ=ŵ₀x+ŵ₁z₁+ŵ₂z₂+ĉ+ε₁ (Expression 10)

When x vector and w_hat vector are expressed in Expression 11 below, y hat is expressed in Expression 12 below.

$$\begin{matrix}[ Math . 4 ] & \\ x = ( \begin{matrix}x \\ {z}_{1} \\ {z}_{2} \\ 1\end{matrix} ) , w = ( \begin{matrix}{\hat{w}}_{0} \\ \hat{{w}_{1}} \\ {\hat{w}}_{2} \\ \hat{c}\end{matrix} ) & ( Expression 11 ) \\ \hat{y} = {\hat{w}}^{T} x + ɛ & ( Expression 12 )\end{matrix}$$

Suppose that past strategy x is generated as in Expression 13 below based on Expression 5 mentioned above.

x=−100z₁+200z₂+500+ε₂ (Expression 13)

In Expression 10 and Expression 13, it is assumed that σ₂² is sufficiently small in ε₁˜N(0, σ₁²), ε₂˜N(0, σ₂₂), compared with σ₁² and the number of data pieces n. Note that N(0, σ²) represents a normal distribution with mean 0 and variance σ².

Here, vectors v₁, v₂, and v₃ are defined. First, v₁ is defined as Expression 14 below. v₁ satisfies Expression 15 below with respect to (x z₁ z₂) that satisfies Expression 13 described above.

$$\begin{matrix}[ Math . 5 ] & \\ {v}_{1} = ( \begin{matrix}- i \\ - 100 \\ - 200 \\ - 500\end{matrix} ) & ( Expression 14 ) \\ {v}_{1}^{T} x = 0 & ( Expression 15 )\end{matrix}$$

Suppose that a least-square method is used as the estimation method. In this case, estimates approximately follow a probability distribution in Expression 16 below by setting true coefficient w^{*T}=(− 1/50−7 14 15). Here, an approximate expression as in Expression 17 is assumed to simplify the description.

$$\begin{matrix}[ Math . 6 ] & \\ \hat{w} \sim {w}^{*} + N ( 0 , Σ ) & ( Expression 16 ) \\ Σ \approx \frac{{σ}_{1}^{2}}{n} ( \frac{1}{{σ}_{2}^{′2}} {v}_{1} {v}_{1} + {\sum }_{i = 2}^{4} {γ}_{i} {v}_{i} {v}_{i}^{T} ) & ( Expression 17 )\end{matrix}$$

In Expression 17, σ₂′=0(σ₂), and γ₂, γ₃, and γ₄ are constants. Further, v₂, v₃, and v₄ including v₁ are normalized vectors orthogonal to one another.

Suppose that realized values tilde z₁ and tilde z₂ (where tilde is superscript ˜) of z₁ and z₂ are obtained upon optimization. In this case, a robust optimization method in an elliptically distributed uncertainty area as in Expression 18 below is considered.

$$\begin{matrix}[ Math . 7 ] & \\ {max}_{x} {\hat{w}}^{T} x - λ ‖ {Σ}^{\frac{1}{2}} x ‖ \\ s . t . x = ( \begin{matrix}x \\ {\tilde{z}}_{1} \\ {\tilde{z}}_{2} \\ 1\end{matrix} ) & ( Expression 18 )\end{matrix}$$

In Expression 18, it is assumed that the estimate value w vector hat and the variance-covariance matrix Σ of the prediction errors are obtained. Note that Σ may also be replaced with the estimate values. Further, λ is a properly selected positive parameter. In this case, Expression 19 below is satisfied.

$$\begin{matrix}[ Math . 8 ] & \\ ‖ {Σ}^{\frac{1}{2}} x ‖ = \frac{{σ}_{1}}{\sqrt{n}} \sqrt{\frac{1}{{σ}_{2}^{′2}} {( {v}_{1}^{T} x )}^{2} + {\sum }_{i = 2}^{4} {{γ}_{i} ( {v}_{i}^{T} x )}^{2}} & ( Expression 19 )\end{matrix}$$

Since 1/σ₂′ is sufficiently larger than σ₁/√n, a price strategy x that does not satisfy Expression 15 mentioned above receives a large penalty in Expression 18 mentioned above. Thus, a price that satisfies Expression 20 below is easily selected.

[Math. 9]

v₁^{T}X≈0 (Expression 20)

Expression 20 mentioned above is equivalent to satisfying Expression 13 mentioned above. Therefore, in the above specific example, it corresponds to that “a low price is put on a sunny day.”

The above content is generalized as follows: The optimization problem with the strategy x for a true parameter θ* is defined in Expression 21.

$$\begin{matrix}[ Math . 10 ] & \\ {min}_{x ∈ X} {θ}^{* T} v ( x ) & ( Expression 21 )\end{matrix}$$

In Expression 21, x is a domain and v is a function. Here, a robust optimization problem when an estimate value θ hat instead of θ* and an error distribution are obtained are considered. When the normality of errors is assumed, Expression 22 below is defined typically by using an error variance-covariance matrix Σ. Note that a robust optimization method different from that in Expression 22 may be used. In Expression 22, the second item serves as a penalty for a strategy with large prediction variance.

$$\begin{matrix}[ Math . 11 ] & \\ {min}_{x ∈ X} {\hat{θ}}^{T} v ( x ) + λ ‖ {Σ}^{\frac{1}{2}} v ( x ) ‖ & ( Expression 22 )\end{matrix}$$

Thus, the reason why the selection of the risky strategy can be avoided is described. Further, from the description of the embodiment, the following will also be described. As illustrated in Expression 1 mentioned above, p(y=large|x=high) is not equal to p(y=large|do(x=high)). On the other hand, even when value (do(x=high)) obtained by intervention is used, it is only necessary to leave a feature that can describe the instrumental variable x as well as the feature that can describe the prediction target y. This means content represented in Expression 23 below.

p(y=large|x=high,z=rainy)=p(y=large|do(x=high),z=rainy (Expression 23)

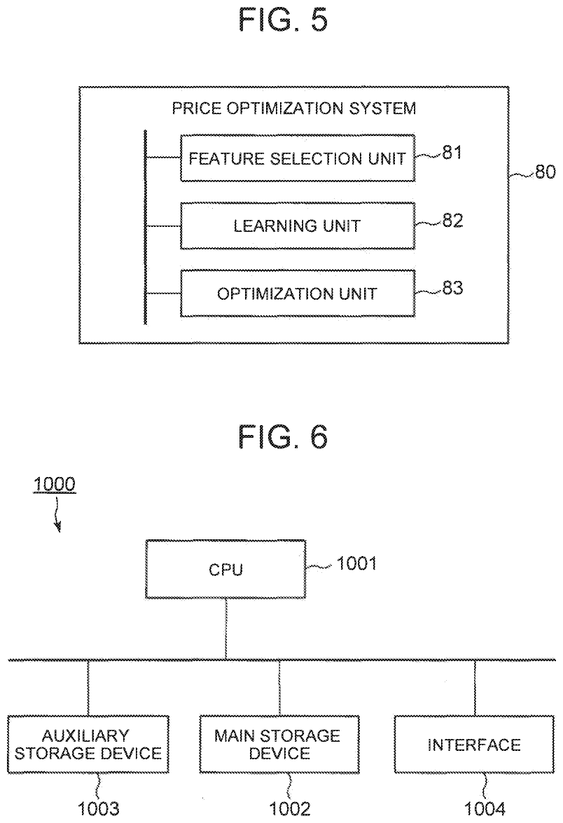

Next, an outline of the present invention will be described. FIG. 5 is a block diagram illustrating an outline of a price optimization system according to the present invention. A price optimization system 80 according to the present invention includes: a feature selection unit 81 (for example, the feature selection unit 20) which selects, from a set of features (for example, candidates for explanatory variable z) that can influence the sales volume of a product, a first feature set as a set of features that influence the sales volume (for example, an explained variable y), and a second feature set as a set of features that influence the price of the product (for example, an instrumental variable x); a learning unit 82 (for example, the learning unit 30) which learns a predictive model in which features included in the first feature set and the second feature set are set as explanatory variables and the sales volume is set as a prediction target; and an optimization unit 83 (for example, the optimization unit 40) which optimizes the price of the product under constraint conditions to increase a sales revenue defined by using the predictive model as an argument.

The learning unit 82 learns a predictive model in which at least one feature included in the second feature set but not included in the first feature set is set as an explanatory variable.

According to such a configuration, when the price is optimized based on prediction, features for optimization of the price can be so selected that a risky strategy can be avoided.

In this case, the learning unit 82 may learn a predictive model in which all of features included in the first feature set and features included in the second feature set are set as explanatory variables.

Specifically, the feature selection unit 81 may perform feature selection processing using the sales volume as an explained variable to acquire the first feature set from the set of features that can influence the sales volume of the product, perform feature selection processing using the price as the explained variable to acquire the second feature set from the set of features that can influence the sales volume of the product, and output a union of the acquired first feature set and second feature set.

Further, the optimization unit 83 may input a distribution of prediction errors according to the learned predictive model to optimize the price of the product using the distribution of prediction errors as a constraint condition.

A specific example of the input distribution of prediction errors is a variance-covariance matrix.

Further, the distribution of prediction errors may be set according to the feature included in the second feature set but not included in the first feature set.

FIG. 6 is a schematic block diagram illustrating the configuration of a computer according to at least one embodiment. A computer 1000 includes a CPU 1001, a main storage device 1002, an auxiliary storage device 1003, and an interface 1004.

The above-described information processing system is implemented on the computer 1000. Then, the operation of each processing unit described above is stored in the auxiliary storage device 1003 in the form of a program (feature selection program). The CPU 1001 reads the program from the auxiliary storage device 1003 and loads the program into the main storage device 1002 to execute the above processing according to the program.

In at least one embodiment, the auxiliary storage device 1003 is an example of a non-transitory, tangible medium. As another example of the non-transitory, tangible medium, there is a magnetic disk, a magneto-optical disk, a CD-ROM, a DVD-ROM, a semiconductor memory, or the like, connected through the interface 1004. Further, when this program is delivered to the computer 1000 through a communication line, the computer 1000 that received the delivery may load the program into the main storage device 1002 to execute the above processing.

Further, the program may also be to implement some of the above-described functions. Further, the program may implement the above-described functions in combination with another program already stored in the auxiliary storage device 1003, that is, the program may also be a so-called differential file (differential program).

### INDUSTRIAL APPLICABILITY

The present invention is suitably applied to a price optimization system for optimizing a price based on prediction. For example, the present invention is also applied suitably to a system for optimizing the price of a hotel. Further, the present invention is suitably applied to a system coupled, for example, a database to output the result of optimization (optimum solution) based on prediction. In this case, for example, the present invention may be provided as a system for collectively performing feature selection processing and optimization processing based on the feature selection processing.

### REFERENCE SIGNS LIST

10 accepting unit
20 feature selection unit
30 learning unit
40 optimization unit
50 output unit
100 price optimization system

What is claimed is:

1. A price optimization system comprising:
a hardware including a processor;
a feature selection unit, implemented by the processor, which selects, from a set of features that can influence a sales volume of a product, a first feature set as a set of features that influence the sales volume and a second feature set as a set of features that influence a price of the product;
a learning unit, implemented by the processor, which learns a predictive model in which features included in the first feature set and the second feature set are set as explanatory variables, and the sales volume is set as a prediction target; and
an optimization unit, implemented by the processor, which optimizes the price of the product under constraint conditions to increase a sales revenue defined by using the predictive model as an argument,
wherein the learning unit learns a predictive model in which at least one feature included in the second feature set but not included in the first feature set is set as an explanatory variable.

2. The price optimization system according to claim 1, wherein the learning unit learns a predictive model in which all of features included in the first feature set and features included in the second feature set are set as explanatory variables.

3. The price optimization system according to claim 1, wherein the feature selection unit performs feature selection processing using the sales volume as an explained variable to acquire the first feature set from the set of features that can influence the sales volume of the product, performs feature selection processing using the price as the explained variable to acquire the second feature set from the set of features that can influence the sales volume of the product, and outputs a union of the acquired first feature set and second feature set.

4. The price optimization system according to claim 1, wherein the optimization unit inputs a distribution of prediction errors according to the learned predictive model to optimize the price of the product using the distribution of prediction errors as a constraint condition.

5. The price optimization system according to claim 4, wherein the input distribution of prediction errors is a variance-covariance matrix.

6. The price optimization system according to claim 4, wherein the distribution of prediction errors is set according to features included in the second feature set but not included in the first feature set.

7. A price optimization method comprising:
selecting, from a set of features that can influence a sales volume of a product, a first feature set as a set of features that influence the sales volume and a second feature set as a set of features that influence a price of the product;
learning a predictive model in which features included in the first feature set and the second feature set are set as explanatory variables, and the sales volume is set as a prediction target; and
optimizing the price of the product under constraint conditions to increase a sales revenue defined by using the predictive model as an argument,
wherein upon learning the predictive model, a predictive model in which at least one feature included in the second feature set but not included in the first feature set is set as an explanatory variable is learned.

8. The price optimization method according to claim 7, wherein a predictive model in which all of features included in the first feature set and features included in the second feature set are set as explanatory variables is learned.

9. A non-transitory computer readable information recording medium storing a price optimization program, when executed by a processor, that performs a method for:
selecting, from a set of features that can influence a sales volume of a product, a first feature set as a set of features that influence the sales volume and a second feature set as a set of features that influence a price of the product;
learning a predictive model in which features included in the first feature set and the second feature set are set as explanatory variables, and the sales volume is set as a prediction target; and
optimizing the price of the product under constraint conditions to increase a sales revenue defined by using the predictive model as an argument,
wherein upon learning the predictive model, a predictive model in which at least one feature included in the second feature set but not included in the first feature set is set as an explanatory variable is learned.

10. The non-transitory computer readable information recording medium according to claim 9, wherein a predictive model in which all of features included in the first feature set and features included in the second feature set are set as explanatory variables is learned.
